(19) United States
(12) Patent Application Publication
(10) Pub. No.: US 2013/0194185 A1
(43) Pub. Date: Aug. 1, 2013

(54) MULTI-SENSOR INPUT DEVICE

(71) Applicant: Logitech Europe S.A., Morges (CH)

(72) Inventors: Padraig McLoughlin, Killygoan (IE); Niall White, Golden (IE); Baptiste Merminod, Carrouge (CH); Vincent Mayor, Rolle (CH); Fabiano Pedrotta, Romanel-sur Morges (CH)

(73) Assignee: Logitech Europe S.A., Morges (CH)

(21) Appl. No.: 13/756,087

(22) Filed: Jan. 31, 2013

Related U.S. Application Data
(60) Provisional application No. 61/593,861, filed on Feb. 1, 2012.

(30) Foreign Application Priority Data
Feb. 7, 2012 (CN) 201010123455.4

(51) Int. Cl. G06F 3/033

(52) U.S. Cl. CPC G06F 3/033
USPC 345/163

(57) ABSTRACT

An input device includes a top panel including a top portion and side portions, a flexible printed circuit board (PCB) configured to detect the presence of a touch object on the top panel and generate a touch signal based on the presence of the touch object on the top panel, and a first flexible adhesive material disposed below top panel and above the flexible PCB, the first flexible adhesive material coupling flexible PCB to the top panel. In certain embodiments, the top panel is seamless. The flexible PCB can detect the presence of the touch object over the top portion of the top panel where the top portion of the top panel has no dead spots.

### CROSS-REFERENCES TO RELATED APPLICATIONS

The present non-provisional application claims priority to U.S. Provisional Patent Application No. 61/593,861, filed on Feb. 1, 2012, and entitled “Multi-Sensor Input Device”; and PRC (China) Patent Application No. 201010123455.4, filed on Feb. 7, 2012, and entitled “Multi-Sensor Input Device,” both of which are incorporated by reference in their entirety for all purposes.

### BACKGROUND OF THE INVENTION

Wireless control devices, including computer mice, provide a means for interacting with a computer. As an example, a mouse can detect two-dimensional motion relative to its supporting surface and be used to move a cursor across a computer screen and provide for control of a graphical user interface. Buttons are typically provided on wireless control devices to enable a user to perform various system-dependent operations. Despite the developments related to wireless control devices, there is a need in the art for improved methods and systems related to such control devices.

### SUMMARY OF THE INVENTION

Embodiments of the invention relate to an input device that includes a top panel with a top portion and side portions, a flexible printed circuit board (PCB) configured to detect the presence of a touch object on the top panel and generate a touch signal based on the presence of the touch object on the top panel. A first flexible adhesive material can be disposed below top panel and above the flexible PCB where the first flexible adhesive material can couple the flexible PCB to the top panel. In certain embodiments, the top panel is seamless. The flexible PCB can detect the presence of the touch object over the top portion of the top panel where the top portion of the top panel has no dead spots.

According to an embodiment of the present invention, an input device is provided. The input device includes a seamless top panel with a top portion and side portions, a flexible printed circuit board (PCB) configured to detect the presence of a touch object on the top panel and generate a touch signal based on the presence of the touch object on the top panel, and a first flexible adhesive material disposed below the top panel and above the flexible PCB. The first flexible adhesive material couples the flexible PCB to the top panel. In some aspects of the invention, the flexible PCB is operable to detect the presence of the touch object over the top portion of the top panel configured above the flexible PCB. The first flexible adhesive material can be coupled to the flexible PCB to the top panel such that no dead spots are created on the top portion of the top panel.

According to certain embodiments, the input device can further include a frame, a top case, where the frame is coupled to the top case. A second flexible adhesive material can be disposed below the flexible PCB and above the frame, where the second flexible adhesive material couples the frame to the flexible PCB. In some aspects, the combination of the top panel, flexible PCB, first flexible adhesive material, frame assembly, second flexible adhesive material, and top case form an upper portion of the input device. The base sub-assembly can include a PCB and a base. The upper portion of the input device and the base sub-assembly can be coupled together to form a body of the input device. The base can include an opening, and the PCB may include a hollow portion operable to increase the distance between the PCB and the opening. In some cases, the PCB provides electro-static discharge (ESD) protection and can be lined with a mylar film, or other suitable non-conductive material.

According to further embodiments, a wireless control device comprises an upper housing including a top panel, and a frame, where the top panel is coupled to the frame. A flexible touch panel can be disposed between the top panel and frame, where the flexible touch panel configured to detect the presence of a touch object on the top panel and generate a touch signal based on the presence of the touch object on the top panel. The top panel can include a top portion and side portions, and the top panel is seamless and coupled to the frame. In some aspects, the wireless control device includes a top case, where the upper housing is coupled to a topside of the top case, and where the upper housing is depressible with respect to the top case. For example, depressing the upper housing may instantiate a button press or other suitable input response.

In further aspects, a base assembly is coupled to a bottom side of the top case. comprising a first flexible adhesive material disposed between the flexible touch sensor and the top panel, the first flexible adhesive material configured to couple the flexible touch sensor to the top panel. In some cases, the top panel disposed above the flexible touch panel has no dead spots. The base sub-assembly can include a printed circuit board (PCB) and a base. An electro-static discharge (ESD) shield can be disposed between the top case and the base assembly and is configured to increase a distance between the PCB and the base and provide ESD protection.

### BRIEF DESCRIPTION OF THE DRAWINGS

FIG. 1 is a simplified schematic diagram of a computer system according to an embodiment of the present invention.

FIG. 2 is a simplified block diagram of a system configured to operate the multi-sensor input device according to an embodiment of the invention.

FIG. 3 is an exploded view illustrating aspects of an input device, according to an embodiment of the invention.

FIG. 4 is an exploded view illustrating aspects of an input device, according to an embodiment of the invention.

FIG. 5A illustrates an input device, according to an embodiment of the invention.

FIG. 5B illustrates various components and aspects of a base sub-assembly, according to an embodiment of the invention.

FIG. 5C illustrates various components and aspects of a base sub-assembly, according to an embodiment of the invention.

FIG. 5D illustrates various components and aspects of a base sub-assembly, according to an embodiment of the invention.

FIG. 5E illustrates various components and aspects of a base sub-assembly, according to an embodiment of the invention.

FIG. 5F illustrates various components and aspects of a base sub-assembly, according to an embodiment of the invention.

FIG. 5G illustrates various components and aspects of a base sub-assembly, according to an embodiment of the invention.

FIG. 5H illustrates a top-case, according to an embodiment of the invention.

FIG. 5I illustrates various aspects of a top-case, according to an embodiment of the invention.

FIG. 5J illustrates various aspects of a top-case, according to an embodiment of the invention.

FIG. 5K illustrates a base of a base sub-assembly, according to an embodiment of the invention.

FIG. 5L illustrates a coupling of a base with a top case at a set of locations, according to an embodiment of the invention.

FIG. 5M illustrates a gap that can be used to accommodate the rotation and pivoting of the top case down on a table or work surface, according to an embodiment of the invention.

FIG. 6 illustrates an ESD shield of an input device, according to an embodiment of the invention

### DETAILED DESCRIPTION

Embodiments of the invention are generally directed to systems and methods for operating a multi-sensor computer input device.

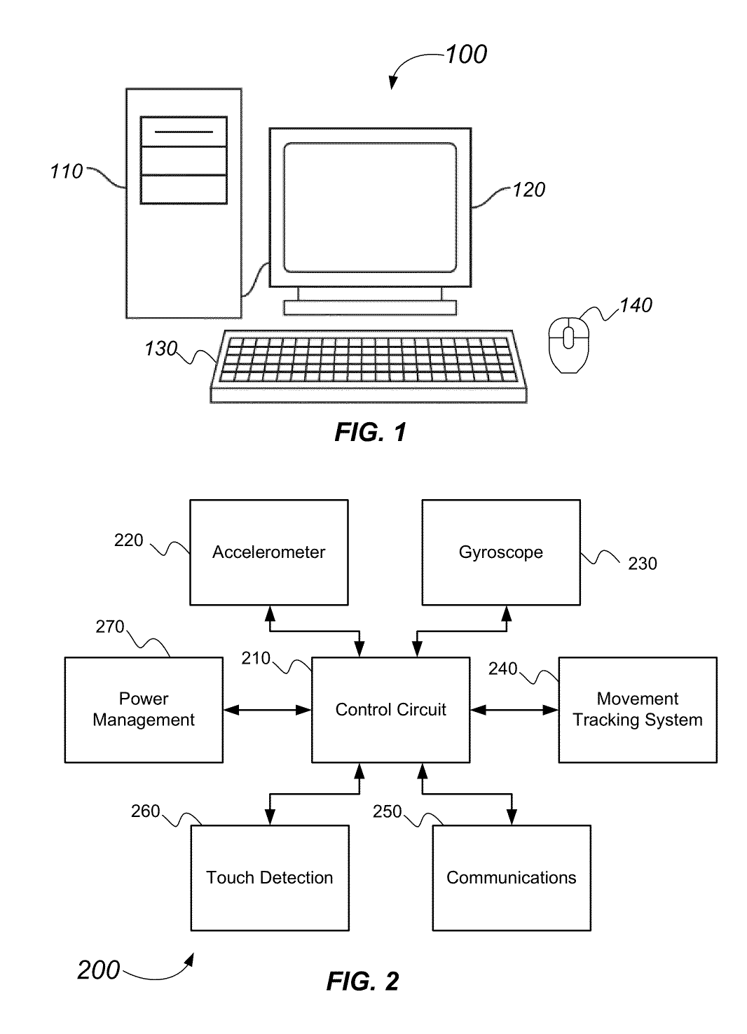

FIG. 1 is a simplified schematic diagram of a computer system 100 according to an embodiment of the present invention. Computer system 100 includes a computer 110, a monitor 120, a keyboard 130, and an input device 140. In one embodiment, the input device 140 is a multi-sensor input device 140. For computer system 100, the input device 140 and the keyboard are configured to control various aspects of computer 110 and monitor 120. In some embodiments, the input device 140 is configured to provide control signals for movement detection, touch detection, gesture detection, lift detection, orientation detection, spurious signal detection, calibration methods, power management methods, and a host of additional features that include, but are not limited to scrolling, cursor movement, selection of on screen items, media control, web navigation, presentation control, and other functionality for computer 110. Computer 110 may include a machine readable medium (not shown) that is configured to store computer code, such as mouse driver software, keyboard driver software, and the like, where the computer code is executable by a processor (not shown) of the computer 110 to affect control of the computer 110 by the input device 140 and keyboard 130. It should be noted that the input device 140 may be referred to as a computer mouse, input device, input/output (I/O) device, user interface device, control device, a multi-sensor input device, a multi-sensor mouse, and the like.

FIG. 2 is a simplified block diagram of a system 200 configured to operate the multi-sensor input device 140, according to an embodiment of the invention. The system 200 includes a control circuit 210, one or more accelerometers 220, one or more gyroscopes 230, a movement tracking system 240, a communications system 250, touch detection system 260, and power management block 270. Each of the system blocks 220-270 are in electrical communication with the control circuit 210. System 200 may further include additional systems that are not shown or discussed to prevent obfuscation of the novel features described herein.

In certain embodiments, the control circuit 210 comprises one or more microprocessors (μCs) and is configured to control the operation of system 200. Alternatively, the control circuit 210 may include one or more microcontrollers (MCUs), digital signal processors (DSPs), or the like, with supporting hardware/firmware (e.g., memory, programmable I/Os, etc.), as would be appreciated by one of ordinary skill in the art with the benefit of this disclosure. Alternatively, MCUs,μCs, DSPs, and the like, may be configured in other system blocks of system 200. For example, the touch detection system 260 may include a local microprocessor to execute instructions relating to a two-dimensional touch surface (not shown). In some embodiments, multiple processors may provide an increased performance in system 200 speed and bandwidth. It should be noted that although multiple processors may improve system 200 performance, they are not required for standard operation of the embodiments described herein.

In certain embodiments, the accelerometers 220 are electromechanical devices (e.g., micro-electromechanical systems (MEMS) devices) configured to measure acceleration forces (e.g., static and dynamic forces). One or more accelerometers can be used to detect three dimensional (3D) positioning. For example, 3D tracking can utilize a three-axis accelerometer or two two-axis accelerometers. The accelerometers 220 can further determine if the input device 140 has been lifted off of a surface and provide movement data that can include the velocity, physical orientation, and acceleration of the input device 140.

A gyroscope 230 is a device configured to measure the orientation of the multi-sensor input device 140 and operates based on the principles of the conservation of angular momentum. In certain embodiments, the one or more gyroscopes 230 in system 200 are micro-electromechanical (MEMS) devices configured to a detect a certain rotation of the multi-sensor input device 140. The system 200 may optionally comprise 2-axis magnetometers in lieu of, or in combination with, the one or more gyroscopes 230. The gyroscope 230 (and/or magnetometers) can further determine if the input device 140 has been lifted off of a surface and provide movement data that can include the physical orientation of the input device 140.

The movement tracking system 240 is configured to track a movement of the multi-sensor input device 140, according to an embodiment of the invention. In certain embodiments, the movement tracking system 240 uses optical sensors such as light-emitting diodes (LEDs) or an imaging array of photodiodes to detect movement of the multi-sensor input device 140 relative to an underlying surface. The multi-sensor input device 140 may optionally comprise movement tracking hardware that utilizes coherent (laser) light. In certain embodiments, one or more optical sensors are disposed on the bottom side of multi-sensor input device 140 (not shown). The movement tracking system 240 can provide positional data (e.g., X-Y coordinate data) or lift detection data. For example, an optical sensor can determine when a user lifts the input device 140 off of a surface and send that data to the control circuit 210 for further processing.

The communications system 250 is configured to provide wireless communication with the computer 110, according to an embodiment of the invention. In certain embodiments, the communications system 250 is configured to provide radio-frequency (RF) communication with other wireless devices. Alternatively, the communications system 250 can wirelessly communicate using other wireless communication protocols including, but not limited to, Bluetooth and infra-red wireless systems. The system 200 may optionally comprise a hardwired connection to the computer 110. For example, the multi-sensor input device 140 can be configured to receive a Universal Serial Bus (USB) cable to provide electronic communication with external devices. Other embodiments of the invention may utilize different types of cables or connection protocol standards to effectuate a hardwired communication with outside entities. In one non-limiting example, a USB cable can be used to provide power to the multi-sensor input device 140 to charge an internal battery (not shown) and simultaneously support data communication between the system 200 and the computer 110.

The touch detection system 260 is configured to detect a touch or touch gesture on one or more touch surfaces on the multi-sensor input device 140, according to an embodiment of the present invention. The touch detection system 260 can include one or more touch sensitive surfaces or touch sensors. Touch sensors generally comprise sensing elements suitable to detect a signal such as direct contact, electromagnetic or electrostatic fields, or a beam of electromagnetic radiation. A touch sensor may be configured to detect at least one of changes in the received signal, the presence of a signal, or the absence of a signal. Further, a touch sensor may include a source for emitting the detected signal, or the signal may be generated by a secondary source. Touch sensors may be configured to detect the presence of an object at a distance from a reference zone or point, contact with a reference zone or point, or a combination thereof. Touch sensors may be configured to detect certain types of objects (objects with certain properties), and not other types of objects. Touch sensors may also be configured to provide a first response when a first type of object is detected, and a second type of response when a second type of object is detected. Similarly, touch sensors may be configured to provide first response with a first type of detection, and a second response with a second type of detection. For example, some touch sensors may operate in different power modes when not actively used. To illustrate, a proximity detection may prompt a device to switch from a sleep mode (e.g., very low power mode) to a low-activity mode of operation. A direct signal detection may prompt a device to switch from a low-activity mode to an active mode (e.g., normal operating power mode).

Various technologies can be used for touch and/or proximity sensing. Examples of such technologies include, but are not limited to, resistive (e.g., standard air-gap 4-wire based, based on carbon loaded plastics which have different electrical characteristics depending on the pressure (FSR), interpolated FSR, etc.), capacitive (e.g., surface capacitance, self-capacitance, mutual capacitance, etc.), optical (e.g., infrared light barriers matrix, laser based diode coupled with photo-detectors that could measure the time of flight of the light path, etc.), acoustic (e.g., piezo-buzzer coupled with some microphones to detect the modification of the wave propagation pattern related to touch points, etc.), etc.

In certain embodiments, the multi-sensor input device 140 has two-dimensional (2D) touch detection capabilities (e.g., x-axis and y-axis movement). Certain embodiments can include touch sensors on the top portion of the input device 140. Other embodiments may include touch sensors located on multiple locations of the input device that may depend on the design of the input device or ergonomic considerations. The multi-sensor input device 140 may optionally comprise surfaces with a one-dimensional touch detection system disposed thereon.

The power management system 270 of system 200 is configured to manage power distribution, recharging, power efficiency, and the like for the multi-sensor input device 140. According to some embodiments, power management system 270 includes a battery (not shown), a USB based recharging system for the battery (not shown), power management devices (e.g., low-dropout voltage regulators—not shown), an on/off button, and a power grid within system 200 to provide power to each subsystem (e.g., accelerometers 220, gyroscopes 230, etc.). In other embodiments, the functions provided by power management system 270 may be incorporated in the control circuit 210.

Mechanical Assembly

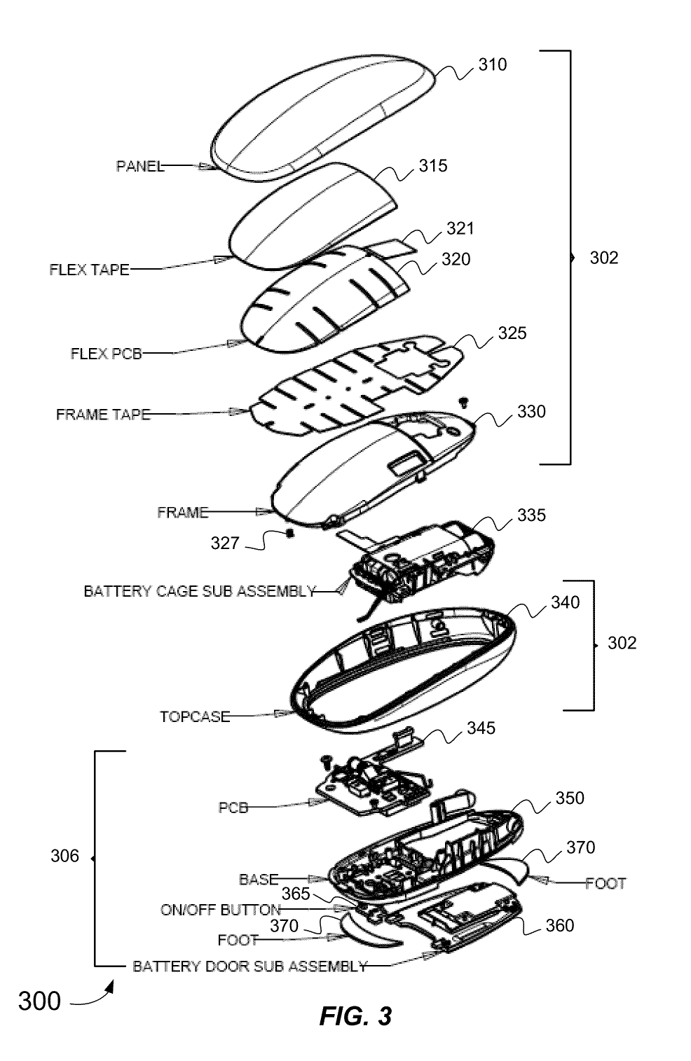

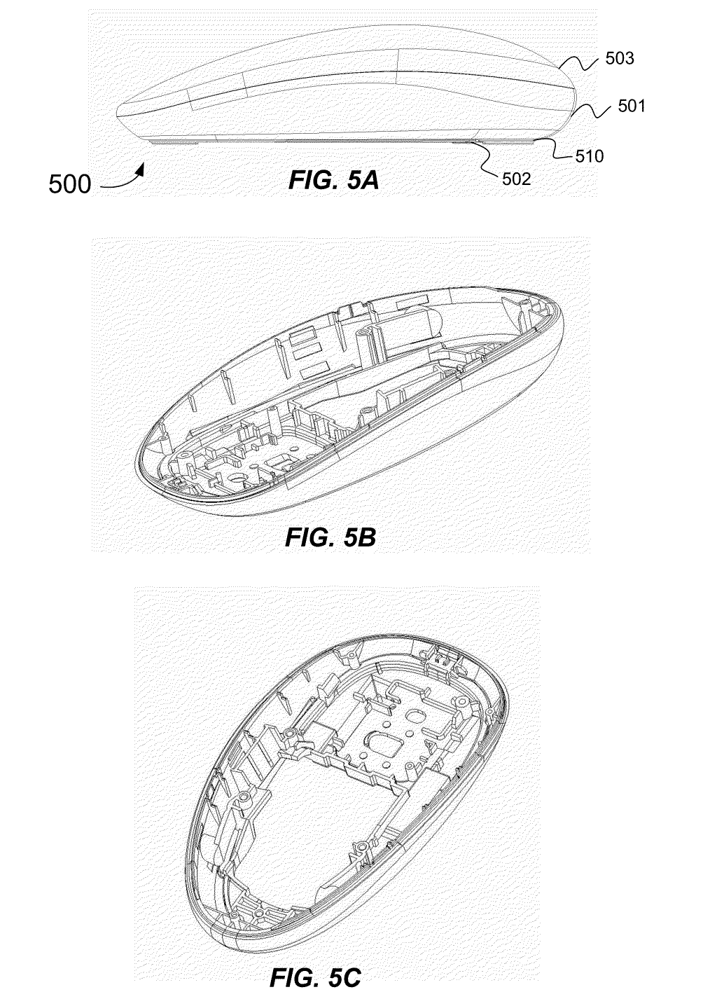

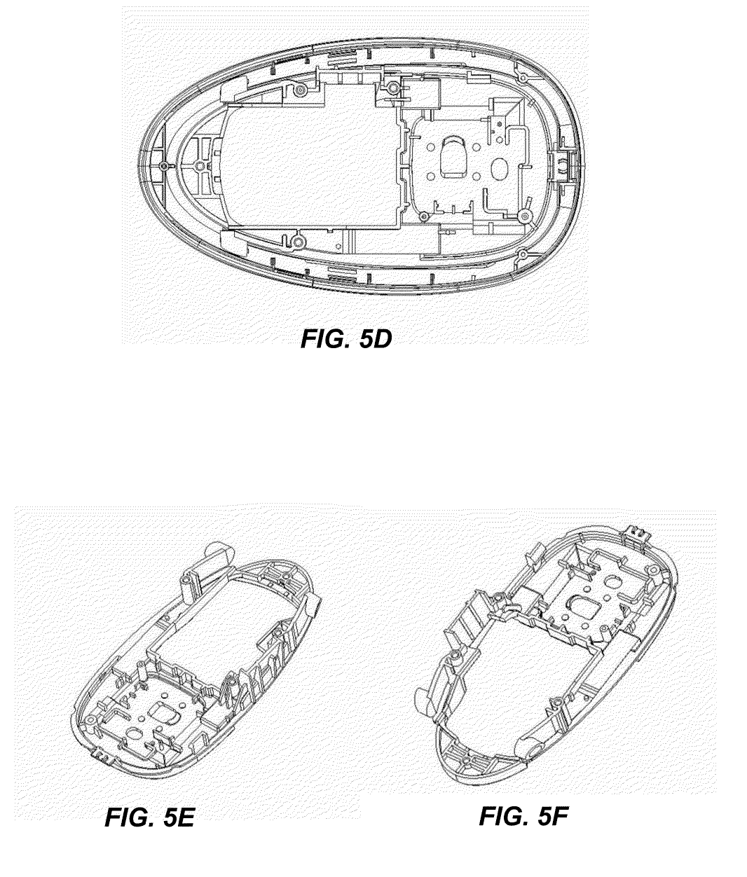

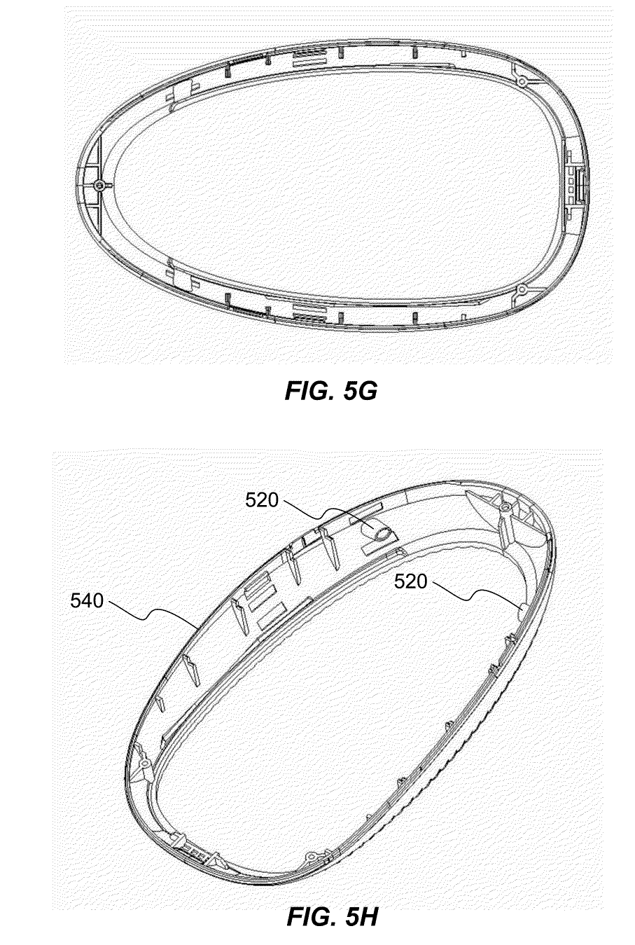

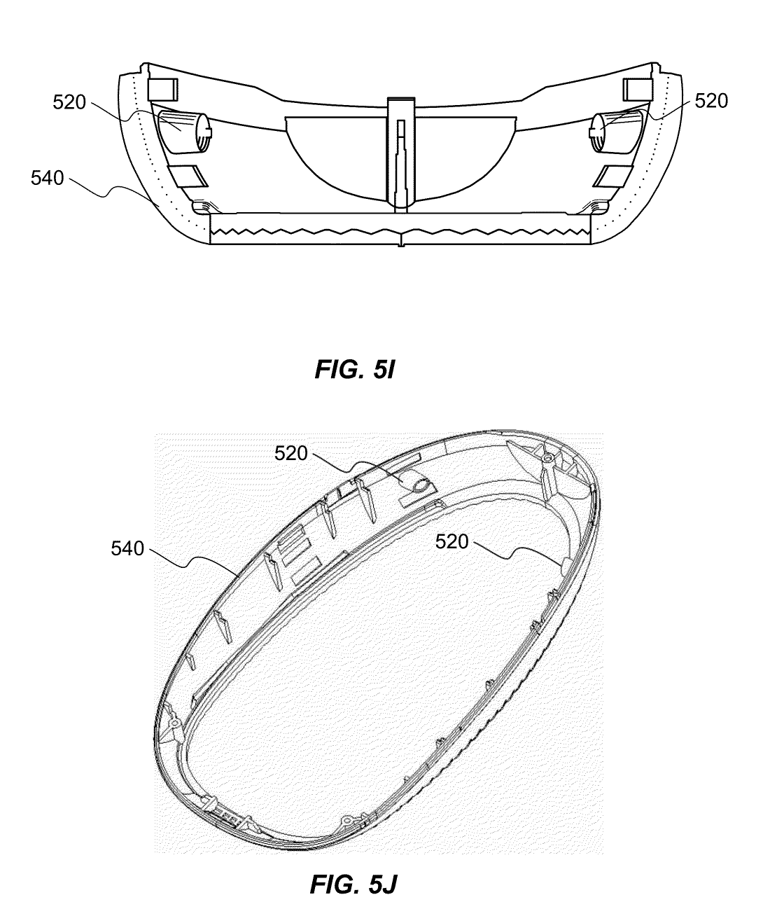

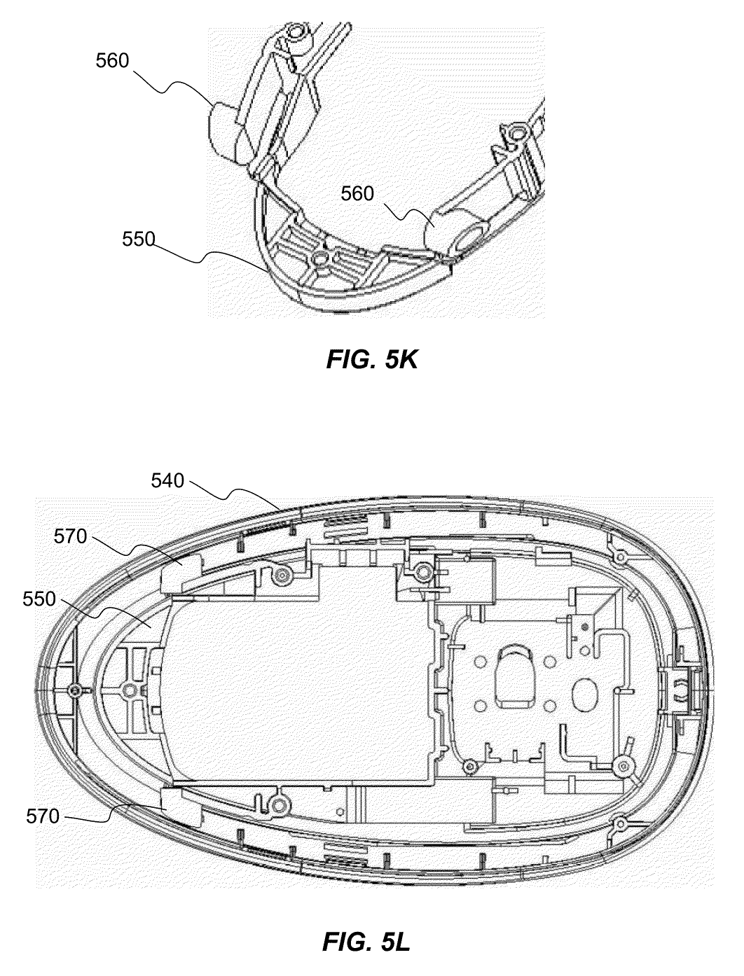

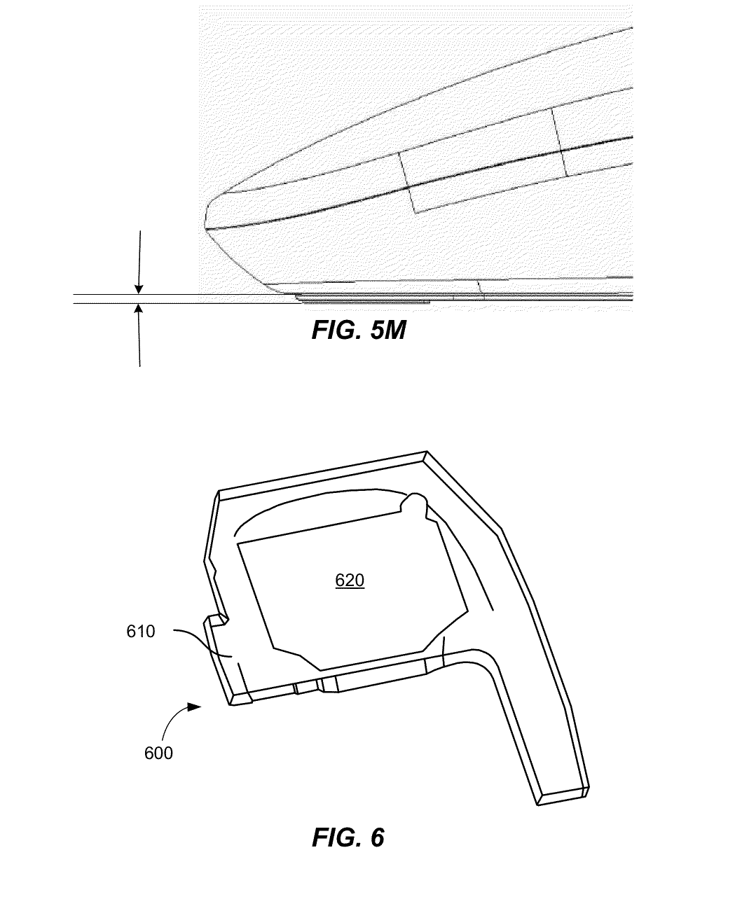

FIG. 3 illustrates an exploded view of an input device 300, according to an embodiment of the invention. The present invention discloses an input device with an upper housing having a touch sensitive surface on the top. The input device 300 includes several sub-assemblies including a base sub assembly 306, a battery cage sub-assembly 335, and an upper housing sub-assembly 302. The base sub-assembly 306 includes a base plate 350, a main printed circuit board (“PCB”) 345 mounted in said base, an on-off button 365, and an optical sensor disposed in the base 350 that is configured to the measure displacement of the input device on a surface such as a desktop. The upper housing 302 is coupled to the base sub-assembly 306 and formed of the panel 310, flex tape 315, flex printed circuit board (“PCB”) 320, frame tape 325, frame 330, and top case 340. The flex PCB 320 includes a flexible flat cable 321, which connects the flex PCB 320 to the PCB 345 for transferring touch sensor data, powering the flex PCB 320, and the like. The upper housing can be depressible. That is, a user can effectuate a button press by depressing the upper housing 302. Alternatively, the input device can have key plates (not shown) that can be moved or depressed. In certain embodiments, the input device 300 is similar to the input device 140 of FIG. 1. The input device 300 does not have any gap or seam along the edge of the outer portion of the mouse to prevent users from pinching their fingers. This feature also provides a more streamlined aesthetic look. This feature is illustrated at least in FIGS. 5A and 5M, as referenced below.

The top panel (“panel”) 310 of the upper housing sub-assembly (upper housing) 302 is comprised of a thin plastic in the illustrated embodiment. In some embodiments, an in-mold labeling (“IML”) pattern is molded onto the thin plastic. IML is a process for decorating plastic parts during the molding process. The panel 310 can be comprised of other suitable materials that would not significantly impede the detection of a touch object on the panel 310 by flex PCB 320. In some cases, the flex tape 315 and flex PCB 320 are pre-connected prior to assembly (e.g., via an adhesive, mechanical means, or the like.). The flex PCB 320 is configured to be attached to the three-dimensional surface of the inside of the panel 310 by adhesive (e.g., flex tape 315), mechanical attachment (e.g., screws, grommets, pins, or the like), or other means. In an exemplary embodiment, the flex tape 315 is a double sided tape. In certain embodiments, the panel 310 is a thin-wall panel. Thin-walled panels provide for a lower power consumption touch sensor than conventional, thicker panels, which currently exist and require greater power consumption requirements to provide accurate tracking of a touch object (e.g., finger). In one embodiment, the panel 310 is approximately 1.1 mm thick, however, panels with other dimensions can be used as needed.

The flex PCB 320 has touch sensitive properties. The flex PCB 320 is attached to the frame 330 by adhesive (e.g., frame tape 325), mechanical attachment (e.g., screws, pins, or the like), or other means. In some embodiments, the frame tape 325 can be similar to flex tape 315. The flex PCB 320 can be a touch surface on which touch pad sensor electrodes are disposed. The sensor electrodes provide accurate tracking of a touch object on the surface of the top panel 310. Tracking can include determining the coordinates, position, movements, etc., of a touch object on the touch panel (flex PCB 320) instead of, or in additional to, the conventional use of mechanical buttons, scroll wheels, and the like. The panel 310 is a cover to protect the touch sensor (i.e., flex PCB 320) and prevent touch objects (e.g., fingers) to come directly in contact with the sensor. The flex PCB 320 can sense a touch object through the flex tape 315 and the panel 310. As described above, a flexible flat cable 321 connects the flex PCB 320 to the PCB 345 for transferring touch sensor data, powering the flex PCB 320, communications, and the like.

The combination of the panel 310, flex tape 315, flex PCB 320, frame tape 325, and frame 330 is configured to be continuous with, and adjusted to, the top case 340, such that there is no gap between them. This configuration is desirable because there are no sharp edges or protrusions that can cause strain or tension when holding or grabbing the input device 300. In other words, the manner in which the panel 310 attaches to the top case 340 provides for a smooth and seamless top and side portion of the input device 300. The panel 310 is a three dimensional surface featuring curvatures that can be adapted for and ergonomically suited to a user's palm. The top case 340 can comprise a two-shot (i.e., two layer) assembly. The inner layer can comprise an ABS plastic or other suitable material. The outer layer can be a transparent polycarbonate (PC) layer. An aesthetic pattern can be configured between the two layers of plastic, which may include a desired emblem, pattern, graphic, and the like.

The touch sensing capabilities of the input device 300 corresponds to the size and surface area of the flex PCB 320. As described above, the flex PCB 320 can be taped beneath the panel 310 via flex tape 315. As such, there are no carve outs in the touch sensing surface needed to accommodate hooks, screws, or other assembly means to fasten the flex PCB 320 to the top panel 310. Thus, the input device 300 provides touch sensing capabilities (e.g., touch gesture recognition) with no “dead zones,” or areas on the surface of panel 310 directly above the flex PCB 320 that do not detect input signals (e.g., areas on the top panel 310 area directly located over hooks, screws, etc., disposed on the flex PCB 120). In some cases, the flexible flat cable 321 may create a dead spot directly above its location. In an exemplary embodiment, the flexible flat cable 321 is arranged such that the surface area of flex PCB 320 under the panel 310 can be maximized to reduce or eliminate dead spots. The flex PCB 320 can be a capacitive touch pad, resistive touch pad, or other suitable technology that would be appreciated by one of ordinary skill in the art.

The base sub-assembly 306 of input device 300 includes a PCB 345, switch (on-off button 365), base 350, feet 370, battery door sub assembly 360 and an optical sensor (not labeled), however alternative embodiments can include additional buttons and/or sensors (e.g., optical sensors, gyroscopes, accelerometers, etc.) or can include fewer sensors. The top case 340 (along with the rest of upper housing 302) can be coupled to the base 350 by a snapping means, hooking means, or a combination thereof. The upper housing 302 is depressible as a whole to perform a button press. In some embodiments, other depressible key plates can be included on the top or sides of the input device 300 for additional functionality. Once in place, the top case 340 locks into position with the battery cage sub-assembly (battery cage) 335. The hooks form a hinge for the input device 300 allowing rotation. In some cases, the base sub-assembly 306 remains stationary as the top case (and upper housing 302) pivot downwards to effectuate a button press. As described above, the panel 310, frame 330 and top case 340 are joined together with layers of double sided tape (e.g., flex tape 315 and frame tape 325) and move as one part as the depressible portion of the input device 300. Alignment features on the top case 340 and base 350 are configured to prevent or reduce any side-to-side movement during rotation of the top case 340 and panel 310. To perform a button press, the panel 310 (and the upper housing assembly 302) can be depressed, which causes the top case to rotate around the hinge. An actuator is configured on the frame that can be pressed down on a tact switch (not shown). Other types of actuators or switches can be used as would be appreciated by one of ordinary skill in the art. The tact switch can be attached (e.g., soldered) on the PCB 345. The PCB 345 can be rigidly affixed to the base by various means including hooks, screws, or the like.

The on-off button 365 and optical sensor are configured to be placed in the base 350. The PCB 345 slides into position on the base 350 and is held in place by a fastening means (e.g., a screw, bolt, grommet, cotter pin, adhesive, tape, etc.). The base 350 is configured to slide into the top case 340. In some embodiments, the base 350 snaps into position on the top case 340 via hinge features positioned at the rear of the base 350 and/or top case 340. Once the base 350 is positioned within the top case 340, the base 350 can pivot and rotate freely from the hinge portion. Some embodiments have hinge features (e.g., on the hinge or part of the top case 340, base 350, etc.) that prevent the base 350 from rotating beyond a desired point.

The battery cage sub-assembly 335 comprises a plastic structure that holds the battery contacts, wire harness, flexible flat cable (“FFC”) 321, and battery release film. The FFC 321 connects to the PCB 345 and the flex PCB 320. Once the base sub-assembly 306 is assembled, the battery cage assembly 335 is configured to be fastened to the base 350 and provides rigidity and support for the input device 300. The battery cage assembly 335 can be fastened via screw, adhesive, tape, bolt, pin, or other fastening means known by those of ordinary skill in the art to rigidly fix the battery cage assembly 335 into position.

The frame tape 330 couples the frame 340 to the flex PCB 320. Similarly, the flex tape 315 couples the flex PCB 320 to the panel 310. The frame tape 325 and/or the flex tape 315 can be double-sided tape. In some cases, a small spring 327 is fastened to the front of the frame 330 to prevent or reduce rattling during the operation of the input device 300 and to add additional force (i.e., resistance) when a user performs a button press on the panel 310. The frame sub-assembly 1004 is configured on top of the top case 340 and fixed in position using 3 screws. Other methods of fastening the frame sub-assembly 1004 to the top of the top case 340 can be used (e.g., adhesives, more/fewer screws, pins, and the like).

The panel sub-assembly 302 is configured to couple to the frame 330 of frame sub-assembly 1004. The feet 370 and battery door sub-assembly 360 are configured to be coupled to the base 350. The feet 370 can be used to help the input device 300 glide on a work surface. The feet 370 can be comprised of Teflon or other suitable material. It should be noted that although some embodiments can include additional hardware and/or features not necessarily depicted in the input device 300 depicted in FIG. 3. For example, certain embodiments can include a nano-receiver configured in the base 350 with the battery cage 335. The control circuit 210, communications module (e.g., RF module with antenna, processor, and supporting circuitry), accelerometers, gyroscopes, and the like, may not explicitly identified in the input device 300 depicted in FIG. 3, but may be included (but not visible) in that particular embodiment, or in other embodiments of the invention.

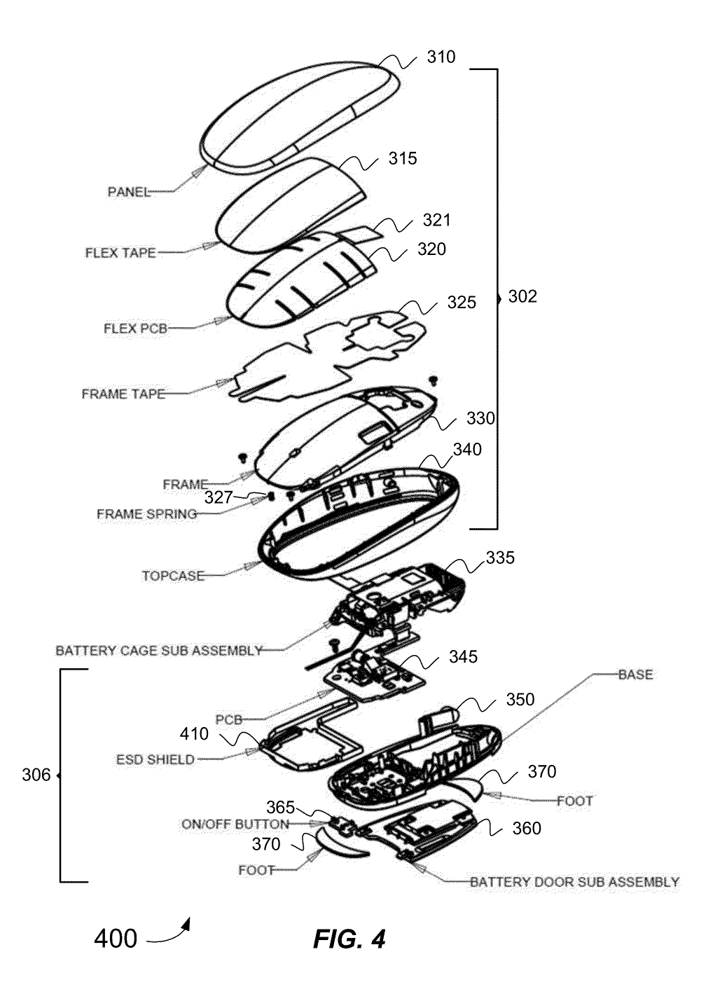

FIG. 4 illustrates an exploded view of an input device 400, according to an embodiment of the invention. Input device 400 is similar to input device 300 with the addition of an electro-static discharge (ESD) shield 410. The ESD shield 410 and similar assemblies can be optional and can provide for a more electrically robust design. The ESD shield 410 is further discussed below with respect to FIG. 6.

FIG. 5A illustrates an input device 500, according to an embodiment of the invention. The input device 500 includes an upper housing 503 and a base sub-assembly 502. Input device 500 can be similar to input devices 300 and 400. As shown, the interface between top case 501 and base sub-assembly 502 is a thin seam 510. The thickness of the seam 510 can vary by design, but is typically very small (e.g., 1 mm) and can vary by design. The seam 510 is further described below with respect to FIG. 6. It should be noted that the entire surface area of upper housing 503 is seamless, as described above.

FIGS. 5B-5G illustrate various components and aspects of a base sub-assembly, according to various embodiments of the invention. These components can be similar to the components that make up base sub-assembly 306 in FIGS. 3 and 4.

FIGS. 5H illustrates a top-case 540, according to an embodiment of the invention. The top case 540 is part of an upper housing, similar to the upper housing 302 of FIGS. 3 and 4. The top case 540 includes a pair of hinges 520. As described above, a base (not shown) snaps into position on the top case 540 via hinges 520 positioned at the rear of the base. Once the base is positioned within the top case 540, the base can pivot and rotate freely from the hinge portion. This pivoting and rotation allows for the upper housing (including the top case 540) to be depressible with respect to the base to effectuate a button press, as described above. FIGS. 5I-5J further illustrate various aspects of the top case 540.

FIG. 5K illustrates a base 550 of a base sub-assembly, according to an embodiment of the invention. The base 550 includes two hinge joints 560. The two hinge joints 560 are adapted to fit inside the hinges 520 shown, for example, in FIGS. 5H-5J. FIG. 5L illustrates the coupling of a base 550 with a top case 540 at a set of locations 570. As described above, the hinges 520 and hinge joints 560 are coupled such that the top case 540 (and the upper housing) can rotate around the base 550 (and the base sub-assembly) as described above. FIG. 5M illustrates a gap that can be used to accommodate the rotation and pivoting of the top case down on a table or work surface. The illustration depicts a 1 mm gap, however other gaps can be used as required. As shown, the top case, including the entire upper housing, is configured to be depressed downward toward the table. This downward movement can trigger an actuator to perform a button press. Some embodiments can include one or more small springs to provide a restoring force to bring the upper housing back to the initial position. It should be noted that the entire upper housing is smooth with no detectable seams to provide a clean, aesthetically pleasing design.

FIG. 6 illustrates an ESD shield 610 of an input device, according to an embodiment of the invention. In some embodiments, the ESD shield 610 provides an improved electrostatic discharge (“ESD”) shielding. The open cavity 620, or center portion of ESD shield 610 can be an opening for the optical sensor to operate the on /off button that can be found on the bottom face. The ESD shield 610 functions to increase the distance between the bottom case opening (not shown) and the PCB 1145, which can further improve ESD performance. In an embodiment, the ESD shield 610 is similar to the ESD shield 410 of FIG. 4. It should be noted that other suitable materials besides Mylar may be used and would be known by those of ordinary skill in the art

The software components or functions described in this application may be implemented as software code to be executed by one or more processors using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

The present invention can be implemented in the form of control logic in software or hardware or a combination of both. The control logic may be stored in an information storage medium as a plurality of instructions adapted to direct an information processing device to perform a set of steps disclosed in embodiments of the present invention. Based on the disclosure and teachings provided herein, a person of ordinary skill in the art will appreciate other ways and/or methods to implement the present invention.

In embodiments, any of the entities described herein may be embodied by a computer that performs any or all of the functions and steps disclosed.

Any recitation of “a”, “an” or “the” is intended to mean “one or more” unless specifically indicated to the contrary.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

What is claimed is:

1. An input device comprising:
a top panel including a top portion and side portions;
a flexible printed circuit board (PCB) configured to detect the presence of a touch object on the top panel and generate a touch signal based on the presence of the touch object on the top panel; and
a first flexible adhesive material disposed below the top panel and above the flexible PCB, the first flexible adhesive material coupling the flexible PCB to the top panel.

2. The input device of claim 1 wherein the top panel is seamless.

3. The input device of claim 1 wherein the flexible PCB is operable to detect the presence of the touch object over the top portion of the top panel configured above the flexible PCB.

4. The input device of claim 1 wherein the top portion of the top panel disposed above the flexible PCB has no dead spots.

5. The input device of claim 1 wherein the first flexible adhesive material couples the flexible PCB to the top panel such that no dead spots are created on the top portion of the top panel.

6. The input device of claim 1 further comprising:
a frame;
a top case, wherein the frame is coupled to the top case; and
a second flexible adhesive material disposed below the flexible PCB and above the frame, the second flexible adhesive material coupling the frame to the flexible PCB, wherein the combination of the top panel, flexible PCB, first flexible adhesive material, frame assembly, second flexible adhesive material, and top case form an upper portion of the input device.

7. The input device of claim 6 further comprising a base sub-assembly including a PCB and a base.

8. The input device of claim 7 wherein the upper portion of the input device and the base sub-assembly are coupled together to form a body of the input device.

9. The input device of claim 7 wherein the base includes an opening, and wherein the PCB includes a hollow portion operable to increase the distance between the PCB and the opening.

10. The input device of claim 9 wherein edges of the hollow portion are lined with a mylar film.

11. A wireless control device comprising:
an upper housing including:
a top panel;
a frame, the top panel coupled to the frame; and
a flexible touch panel disposed between the top panel and frame, the flexible touch panel configured to detect the presence of a touch object on the top panel and generate a touch signal based on the presence of the touch object on the top panel, the top panel including a top portion and side portions, and the top panel being seamless and coupled to the frame;
a top case, wherein the upper housing is coupled to a topside of the top case, and wherein the upper housing is depressible with respect to the top case; and
a base assembly coupled to a bottom side of the top case.

12. The wireless control device of claim 11 further comprising a first flexible adhesive material disposed between the flexible touch sensor and the top panel, the first flexible adhesive material configured to couple the flexible touch sensor to the top panel.

13. The wireless control device of claim 11 wherein the top panel disposed above the flexible touch panel has no dead spots.

14. The wireless control device of claim 11 wherein the base sub-assembly includes a printed circuit board (PCB) and a base.

15. The wireless control device of claim 11 further comprising an electro-static discharge (ESD) shield disposed between the top case and the base assembly.

16. The wireless control device of claim 15 wherein the ESD shield is configured to increase a distance between the PCB and the base.

17. The wireless control device of claim 16 wherein the ESD shield includes a mylar coating.

18. A device comprising:
a top panel;
a first flexible tape;
a flexible printed circuit board (PCB) coupled to the top panel by the first flexible tape, the flexible PCB configured to detect the presence of a touch object on the top panel and generate a touch signal based on the presence of the touch object on the top panel;
a second flexible tape; and
a frame, the flexible PCB coupled to the frame by the second flexible tape.

19. The device of claim 18 wherein the top panel has a top portion and side portions, the top panel is seamless, and the top panel has no dead spots such that the flexible PCB can detect the presence of the touch object over the entire surface of the top panel.

20. The device of claim 18 wherein the device is a computer mouse.
